(19) United States
(12) Patent Application Publication
(10) Pub. No.: US 2009/0005032 A1
(43) Pub. Date: Jan. 1, 2009

(54) Viewing Digital Content on a Mobile Device

(75) Inventors: Stephane Lunati, Fremont, CA (US); Ken Goto, San Francisco, CA (US); Brian Dote, Waipahu, HI (US); Seejo Pylappan, Cupertino, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/873,322

(22) Filed: Oct. 16, 2007

Related U.S. Application Data
(60) Provisional application No. 60/946,941, filed on Jun. 28, 2007.

(51) Int. Cl. H04Q 7/22

(52) U.S. Cl. 455/426.1

(57) ABSTRACT

A computer-implemented method includes receiving from a mobile device communicating over a wireless network a request for a content item, generating an identifier to represent a network location at which the content item is stored, and transmitting the identifier and the content item to the mobile device, wherein the mobile device is configured to perform operations including display the item in a first frame in a user interface on the mobile device, display the identifier in a second frame in the user interface, and enable a user to perform manipulations on the content item.

### CROSS REFERENCE TO RELATED APPLICATION

This application claims the benefit of the filing date of U.S. Provisional Application Ser. No. 60/946,941, filed on Jun. 28, 2007, and entitled “Viewing Digital Content on a Mobile Device”, the entire disclosure of which is incorporated herein by reference.

### TECHNICAL FIELD

This disclosure relates to viewing digital content such as digital images, digital video, and the like, on a user interface of a mobile device located at a remote location.

### BACKGROUND

Mobile devices, such as cellular telephones, can be embedded with several features that enable multiple functions in addition to making and receiving telephone calls. One of the embedded features can include a digital camera to capture digital content including images, video, and the like. The mobile device can also be configured to enable transmission of the captured content from a first mobile device to a second mobile device and also from a first mobile device to a storage device operatively coupled to each other via wireless means, e.g., over a cellular telephone network. In addition, mobile devices can be configured to request and receive content and display the received content on a user interface of the mobile device. In response to a request from a mobile device, content located at a remote network location, as well as identifiers representing the content, can be transmitted to the mobile device. The mobile device can display both the content and the identifiers in the user interface and enable sharing the content, e.g., by sharing the identifier representing the content with other mobile devices.

### SUMMARY

In one example, upon receiving an input from a user, a request is transmitted from a mobile device to a remote location. In response, an identifier representing the content is generated, and the content and the identifier are transmitted to the mobile device for display in a user interface on the mobile device. Subsequently, the identifier is stored, and when the stored identifier is accessed, the content is retrieved from the network location, and presented in the user interface on the mobile device, in the absence of changes to the content.

In one aspect, a computer-implemented method includes receiving from a mobile device communicating over a wireless network a request for a content item, generating an identifier to represent a network location at which the content item is stored, and transmitting the identifier and the content item to the mobile device, wherein the mobile device is configured to perform operations including display the item in a first frame in a user interface on the mobile device, display the identifier in a second frame in the user interface, and enable a user to perform manipulations on the content item.

This, and other aspects, can include one or more of the following features. The manipulations can include at least one of viewing, zooming, panning, and scrolling. The device can be the mobile device and the network can be the wireless network. The identifier can be a uniform resource locator. The content item can be a digital image. The method can include receiving the digital image from a device over a network, detecting that the device requesting the item of content is the mobile device, generating one or more low resolution versions of the digital image, generating one or more low resolution identifiers corresponding to the one or more low resolution versions, and transmitting one of the low resolution versions and the corresponding low resolution identifier to the mobile device. The method can further include storing the transmitted identifier, receiving a second request for the content item from a second mobile device over the network, and upon determining that the content item is unchanged in the duration between when the first request was received and the second request is received, transmitting the stored identifier and the item of digital content to the second mobile device. The method can further include receiving a plurality of content items, storing the plurality of items in a repository at the network location, generating a second identifier to represent the repository, and upon receiving a request from a mobile device over the wireless network for the plurality of items, transmitting the second identifier to the mobile device. The mobile device can be configured to perform operations including displaying each item of the plurality of items in corresponding frames arranged in one or more rows on a user interface on the mobile device, displaying the second identifier in an identifier frame on the user interface, and enabling a user to perform manipulations on the plurality of items, displaying in the user interface only the selected one of the plurality of items, and navigating to access a first view displaying one of the plurality of items or a second view displaying the plurality of items.

In another aspect, a medium bearing instructions to enable one or more machines to perform operations is described. The operations include receiving from a mobile device communicating over a wireless network a request for a content item, generating an identifier to represent a network location at which the content item is stored, and transmitting the identifier and the content item to the mobile device, wherein the mobile device is configured to perform operations including display the item in a first frame in a user interface on the mobile device, display the identifier in a second frame in the user interface, and enable a user to perform manipulations on the content item.

This, and other aspects, can include one or more of the following features. The manipulations can include at least one of viewing, zooming, panning, and scrolling. The device can be the mobile device and the network can be the wireless network. The identifier can be a uniform resource locator. The content item can be a digital image. The operations can include receiving the digital image from a device over a network, detecting that the device requesting the item of content is the mobile device, generating one or more low resolution versions of the digital image, generating one or more low resolution identifiers corresponding to the one or more low resolution versions, and transmitting one of the low resolution versions and the corresponding low resolution identifier to the mobile device. The operations can further include storing the transmitted identifier, receiving a second request for the content item from a second mobile device over the network, and upon determining that the content item is unchanged in the duration between when the first request was received and the second request is received, transmitting the stored identifier and the item of digital content to the second mobile device. The operations can further include receiving a plurality of content items, storing the plurality of items in a repository at the network location, generating a second identifier to represent the repository, and upon receiving a request from a mobile device over the wireless network for the plurality of items, transmitting the second identifier to the mobile device. The mobile device can be configured to perform operations including displaying each item of the plurality of items in corresponding frames arranged in one or more rows on a user interface on the mobile device, displaying the second identifier in an identifier frame on the user interface, and enabling a user to perform manipulations on the plurality of items, displaying in the user interface only the selected one of the plurality of items, and navigating to access a first view displaying one of the plurality of items or a second view displaying the plurality of items.

In another aspect, a computer-implemented method includes transmitting a request for one or more content items from a mobile device, receiving one or more identifiers corresponding to the one or more content items, and upon detecting that a user has selected an identifier of the one or more identifiers, retrieving a corresponding item, and displaying an image corresponding to the corresponding item in a frame in a user interface on the mobile device.

This, and other aspects, can include one or more of the following features. The identifier can correspond to one or more items collected into a group. The method can include displaying the one or more items of the group in an array of frames, wherein an image corresponding to an item is displayed in a frame in the array. The method can include displaying the identifier corresponding to the group in a frame adjacent to the array. An identifier can correspond to a plurality of groups, a group corresponding to one or more items. The method can further include displaying the plurality of groups in an array, wherein a row in the array includes at least a first frame containing information enabling identification of a first group and at least a second frame displaying an image corresponding to an item in the first group. The information enabling identification of a first group can include a name of the first group. The method can further include displaying the identifier corresponding to the plurality of groups in a frame adjacent to the array. The method can further include displaying navigation buttons adjacent to the array wherein the navigation buttons enable the user to access items in a group.

In another aspect, a medium bearing instructions to enable one or more users to perform operations is described. The operations include transmitting a request for one or more content items from a mobile device, receiving one or more identifiers corresponding to the one or more content items, and upon detecting that a user has selected an identifier of the one or more identifiers, retrieving a corresponding item, and displaying an image corresponding to the corresponding item in a frame in a user interface on the mobile device.

This, and other aspects, can include one or more of the following features. The identifier can correspond to one or more items collected into a group. The operations can include displaying the one or more items of the group in an array of frames, wherein an image corresponding to an item is displayed in a frame in the array. The operations can include displaying the identifier corresponding to the group in a frame adjacent to the array. An identifier can correspond to a plurality of groups, a group corresponding to one or more items. The operations can further include displaying the plurality of groups in an array, wherein a row in the array includes at least a first frame containing information enabling identification of a first group and at least a second frame displaying an image corresponding to an item in the first group. The information enabling identification of a first group can include a name of the first group. The operations can further include displaying the identifier corresponding to the plurality of groups in a frame adjacent to the array. The operations can further include displaying navigation buttons adjacent to the array wherein the navigation buttons enable the user to access items in a group.

The systems and techniques described here can present one or more of the following advantages. Displaying images, a group of images, and multiple groups of images in a user interface on a mobile device can enable viewing and editing images on the mobile device. Including navigation tools in the user interface to switch between displays can improve user experience. Providing the user with identifiers representing items of digital content can enable accessing the items as well as sharing the items among other users. Thus, while one user can capture and store content in a remote location, several users, including the user who captured the content, can access the content when provided with the identifier pointing to the remote location where the content is stored.

The details of one or more implementations are set forth in the accompanying drawings and the description below. Other features and advantages will be apparent from the description and drawings, and from the claims.

### DESCRIPTION OF DRAWINGS

FIG. 1 is a schematic of an example of a system for requesting content to be presented on a mobile device.

FIG. 2 is a schematic of an example of a system including a mobile publishing engine for receiving and transmitting content over a network.

FIGS. 3-5 are schematics of user interfaces on mobile devices.

FIG. 6 is a flow chart of an example of a process for receiving requests from and transmitting content to a mobile device.

FIG. 7 is a flow chart of an example of a process for displaying items on a mobile device.

Like reference symbols in the various drawings indicate like elements.

### DETAILED DESCRIPTION

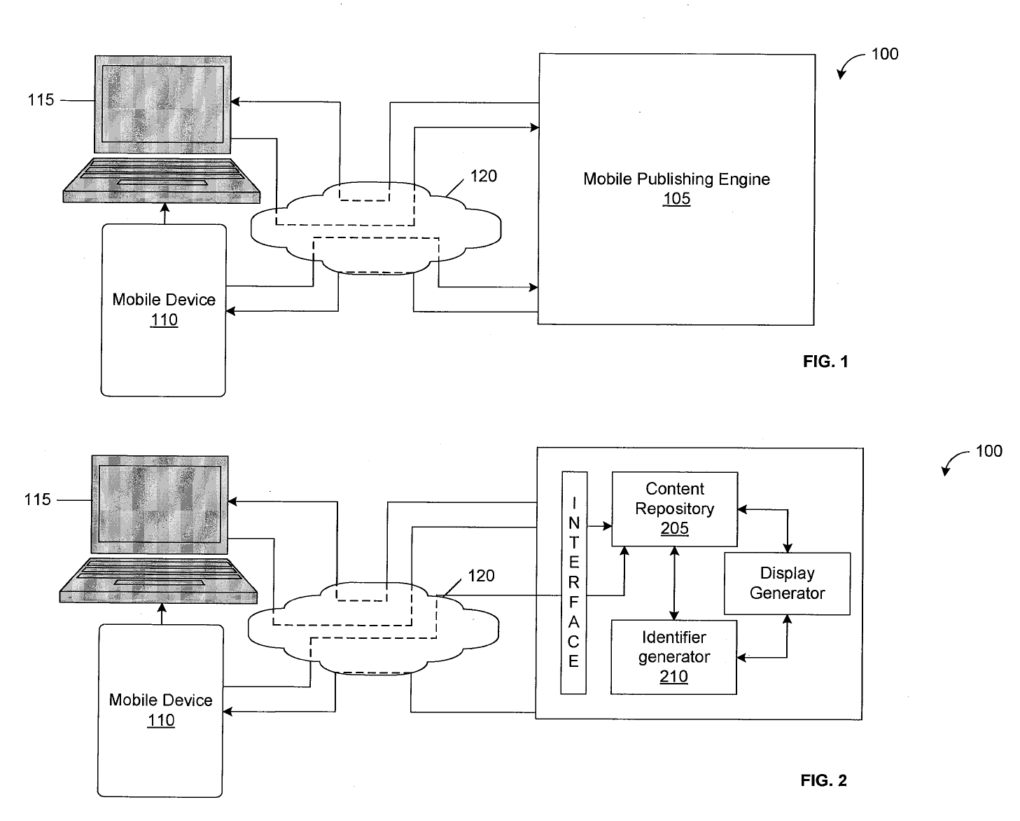

FIG. 1 depicts a schematic of an example of a system 100 for receiving requests for digital content from one or more devices. The system 100 can include a mobile publishing engine (MPE) 105 configured to receive digital content, such as digital images, digital video, audio, documents, and the like, from one or more devices including a mobile device 110, a computer 115, and the like, over a network 120. In some implementations, the MPE 105 can be located at a remote network location with which one or more devices can interact through a web page of a web site offered by the MPE 105. The mobile device 110 can be a cellular telephone, a digital camera, a digital camcorder or virtually any device capable of storing digital content and transmitting the content over the network 120. In some implementations, the mobile device 110 can be a cellular telephone into which digital content capturing and storing features are incorporated. The cellular telephone can be operatively coupled to the MPE 105 over a network such as a cellular telephone network. The computer 115 can be virtually any computer such as a desktop computer, a laptop computer, a personal digital assistant (PDA), and the like, that can be operatively coupled to the MPE 105 over a network 120 such as the internet. In some implementations, the mobile device 110 can also be operatively coupled to the computer 115. For example, a digital camera used to capture digital images can be operatively coupled, e.g., docked, to a computer 115, e.g., a desktop computer, which, in turn, can be operatively coupled to the MPE 105 via the internet.

In some implementations, a user can create storage space to store digital content, e.g., digital images, on the MPE 105. For example, the MPE 105 can offer a web site, e.g., www.mpe.com, that a user can access using a computer 115 connected to the internet. The user can create an account on the MPE 105 and can be allocated storage space. The user can capture digital images using suitable devices and transmit the captured images to the allocated storage space over the network. In some implementations, the device can be a cellular telephone in which a digital camera is incorporated. A user can capture and transmit the images using, e.g., the cellular telephone. In other implementations, the user can capture the images using a digital camera, and transfer the images from the digital camera to the MPE 105 through a computer 115.

Subsequently, a user of a mobile device 110 can request access to the digital images stored in the MPE 105. When the MPE 105 receives a request, from any device, for access to stored digital images, the MPE 105 can generate identifiers, e.g., uniform resource locators (URLs), for each stored digital image. The MPE 105 can transmit the images and the identifiers to the requesting device for presentation on the requesting device. In implementations where the requesting device is a mobile device 110, the mobile device 110 can include a user interface on which the images and the identifiers can be displayed. In some implementations, one or more images can be automatically grouped into a container representing an album or can be grouped based on user input, or both. The MPE 105 can be configured to generate identifiers to represent each container, in addition to generating an identifier to represent each image in each container. The user interface on the mobile device 110 can include navigation tools that can enable a user to navigate the storage space. Using the navigation tools, the user can display, on the user interface of the mobile device 110, all the containers in the storage space, an array of images in each container, e.g., as a photo gallery, as well as individual images in a container. In addition to displaying the images in the storage space, the user interface can also be configured to display the identifier corresponding to the location of the images to enable a user to, e.g., share the images with other users over the network.

FIG. 2 depicts a schematic of an MPE 105 in a system 100 configured to receive content from devices including a mobile device 110 and a computer 115, over a network 120, and to transmit content to the device upon receiving requests. In some implementations, the MPE 105 can be located at a remote network location to which content, e.g., digital images, can be transferred, e.g., uploaded, directly from a computer 115. Alternatively, or in addition, the digital images can be transmitted to the MPE 105 via messages, such as electronic mail (e-mail) messages to which the images are attached, from a mobile device 110, from a computer 115, or both. The MPE 105 can include a content repository 205 in which the received images can be stored. For example, a user can interact with the MPE 105 through an interface to perform operations such as creating an account, accessing the account, and the like. When a user creates an account, the MPE 105 can allocate storage space in the content repository 205 to the user. The user can transmit content to the MPE 105 for storage in the content repository 205. In some implementations, the user can create containers, representing, e.g., an album of images, and store the images in one or more containers. Alternatively, or in addition, the containers can be automatically created by the MPE 105. Further, the mobile device 110 using which the user captures the images can create containers to store the images. The MPE 105 can receive and store a container including all the images in the container.

In some implementations, the MPE 105 can include an identifier generator 210 that can be configured to generate a unique identifier, e.g., a URL, to represent each image received from a user. When the MPE 105 receives containers including images, the MPE 105 can store the containers in the content repository 205. When the MPE 105 receives a request from a device to access the images over a network 120, in response to the request, the identifier generator 210 can generate a URL to identify the location of each image in the repository, as well as to identify the location of each container containing the images. The MPE 105 can transmit the URL and the images to the requesting device. The images, the container containing the images, and the multiple containers can be displayed on display device operatively coupled to the requesting device. In addition, the URLs corresponding to the displayed content can also be displayed on the display device. In implementations where the content is shared, a user of the requesting device can select a URL representing one of an image, a container including multiple images, multiple containers, and the like. Upon detecting that a URL has been selected, the MPE 105 can retrieve the selected image from the content repository 205 and transmit the image to the requesting device. In this manner, the requesting device can display the selected image, selected container, or selected plurality of containers in a user interface.

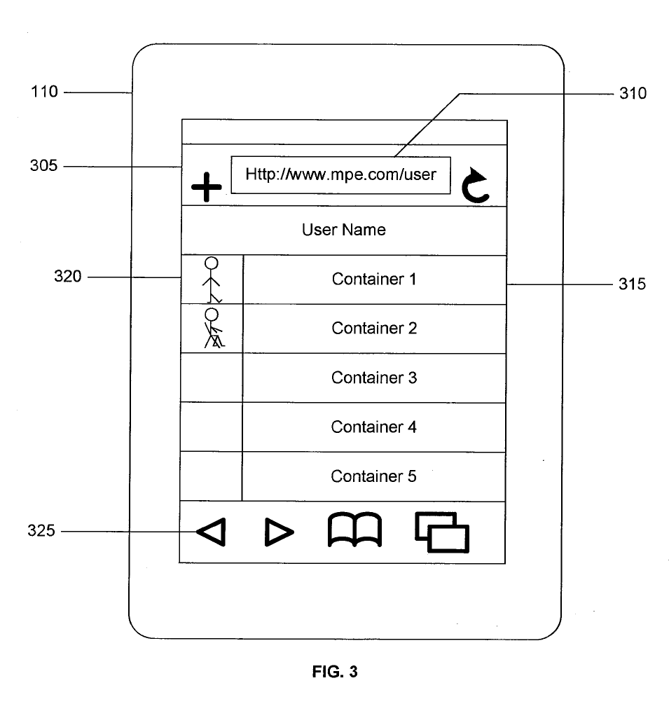

FIG. 3 depicts a schematic of a user interface (UI) 305 on a mobile device 110 in which content received from the MPE 105 can be displayed. In some implementations, the requesting device can be the mobile device 110, e.g., a cellular telephone including features to access the MPE 105 over a network, capture content, display content, and the like. The mobile device 110 can include a UI 305 in which information related to content in the content repository 205 including the identifier pointing to the content, one or more containers containing content, and navigation buttons in the mobile device 110, can be displayed. A user of the mobile device 110 can request images to be displayed on the UI 305 by entering the identifier, pointing to the location at which the images are located in the MPE 105, in an identifier tool 310. The identifier tool 310 can be a frame in which text can be entered and displayed. In some implementations, the identifier can be a string of text which the user can enter into the identifier tool 310 using a key board included in the mobile device 110. In other implementations, the identifier can be a hyperlink displayed on the UI 305 that the user can select. Selecting the identifier can cause a request to be transmitted to the MPE 105. The MPE 105 can retrieve content, e.g., images, containers of images, and the like, and transmit the retrieved content to be displayed in the UI 305. In some implementations, the identifier can include a user name that corresponds to the user's account on the MPE 105. The mobile device 110 can be configured to display the user name in the UI 305. In addition, in some implementations, the UI 305 can display the containers in the content repository 205 as an array including one or more rectangular frames, each frame displaying a name under which the container is stored as well as an image representing each container.

For example, the content repository 205 associated with a user can include 5 containers, each container including one or more images. The mobile device 110 can be configured to display, in the UI 305, the identifier representing the location of all the containers in the identifier tool 310. In addition, the mobile device 110 can be configured to display the user name in a frame in the UI 305. Also, for the example of the content repository including 5 containers, the mobile device 110 can be configured to display in the UI 305, an array of rectangular frames comprising 2 columns and 5 rows, wherein each row can represent a container. The frame in the second column (315) can represent a name associated with a container while the frame in the first column (320) can display, within the frame, an image in the container. The MPE 105 can transmit the name associated with the container, in addition to the container and the corresponding images. The mobile device 110 can be configured to identify the name for displaying in the corresponding container name frame 315. In addition, the image in a container displayed in the image frame 320 can be selected by the MPE 105, selected by the owner of the user account, or can be recommended by the MPE 105 and over written by the user. For example, the MPE 105 can select the first image in the container to be displayed in the image frame 320. The owner of the user account can replace the image with a different image in the container. In this manner, one or more containers in the content repository 205 can be displayed as frames in the UI 305. The mobile device 110 can include navigation tools 325 that can enable accessing individual images within containers, changing the display of images, and the like.

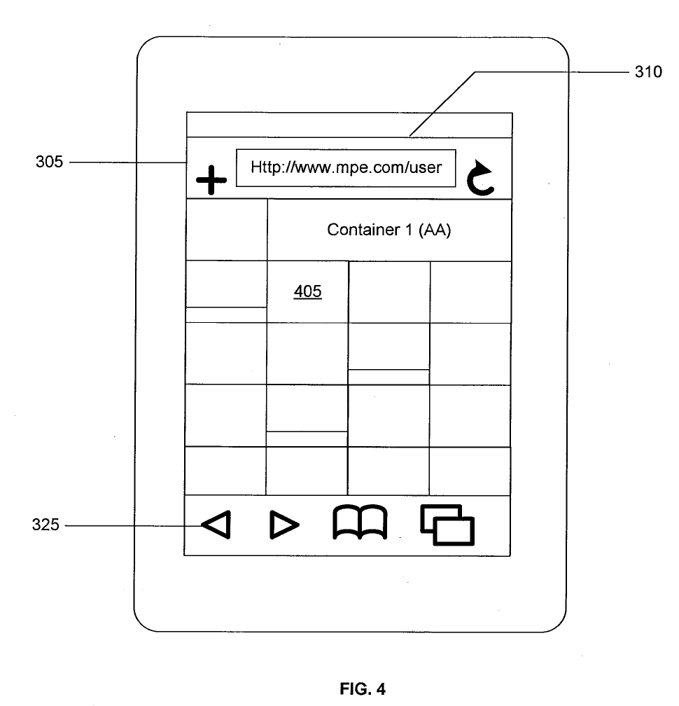

FIG. 4 depicts a schematic of a mobile device 110 including a UI 305 displaying the contents of a container in corresponding frames. When the user selects a frame representing a container, e.g., by touching the frame with the user's finger, a stylus, and the like, the display in the UI 305 can be altered to display all the items of content in the selected container in an array of frames. The array of frames can each display an image in the container. The sequence in which the images in the array are arranged can correspond to the sequence in which the images were captured. Alternatively, based on user input, the sequence can be altered, e.g., displayed according to a name associated with each image. In addition, the UI 305 can display the identifier tool 310, the navigation buttons 325, and the name of the accessed container as well as the number of items in the container. The identifier tool 310 can display the URL that points to the location of the container in the MPE 105. Each item of content in the container can be displayed in a corresponding frame 405. A user can select an item to further access the item.

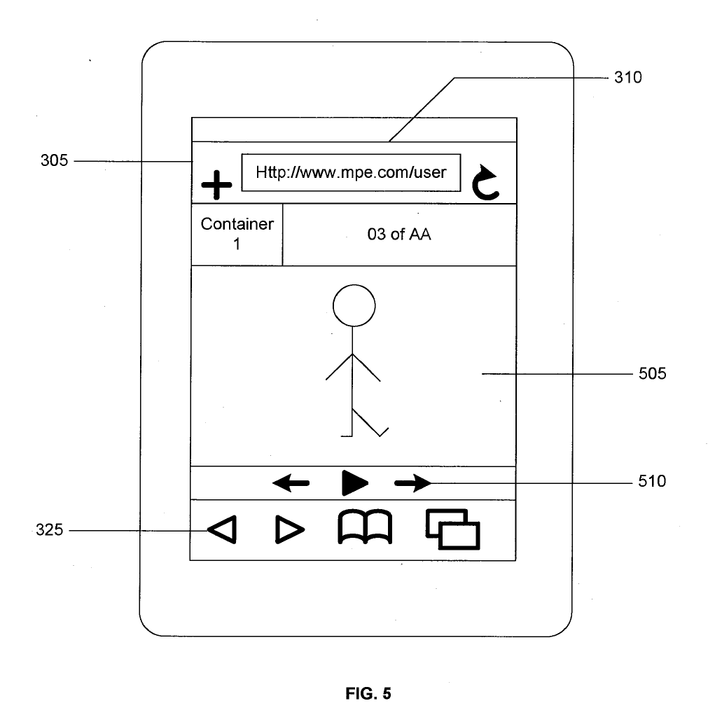

FIG. 5 depicts a schematic of a mobile device 110 including a UI 305 in which an item of digital content is displayed. In some implementations, a user can select one of the frames 405 to further access the content. For example, if a user selects a frame 405 representing an image, then the selected image can be displayed in a corresponding frame 505 in the UT 305 and the other frames of the container can be hidden from view. In such implementations, the mobile device 110 can be configured to display scroll buttons 510 adjacent to the frame 505 in which a selected frame is displayed. The user can select the scroll buttons to access the next or previous image in the container relative to the image displayed in the UT 305. Further, the user can use the navigation buttons 325 to access the view displaying, in an array, the images in the container, the view displaying, in an array, all the containers in the content repository 205, and the like. Further, when an image is displayed in the UT 305, the identifier corresponding to the displayed image can be displayed in the identifier tool 310.

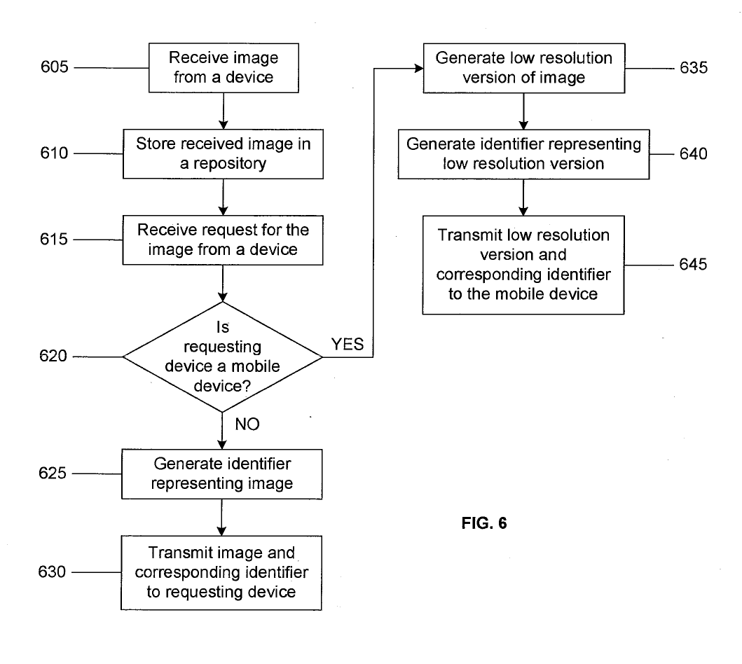

FIG. 6 depicts a flow chart of an example of a process for transmitting items of digital content to a mobile device from a network location in response to a request received from the mobile device. An image can be received from a device at 605 and stored in a repository at 610. In some implementations, the image can be received from a mobile device operatively coupled to the repository over a wireless network such as a cellular telephone network. In other implementations, the image can be received from a computer operatively coupled to the repository over a network such as the internet. The repository can be located at a remote network location with which a user can interact via a web page of a web site. In some implementations, more than one image can be received for storage in the repository. In addition, content other than images, e.g., digital video, audio, documents, and the like, can also be received by the repository for storage.

Depending on the resolution of the image, the file size representing the image can be in the order of a few megabytes. A request can be received for the image from a device at 615. A check can be performed to determine if the requesting device is a mobile device at 620. In some implementations, the mobile device from which the image is received can also be the device requesting the image. Alternatively, the image can be received from a computer and the request can be received from a mobile device. If the request is received from a device operatively coupled to the repository over a strong network connection, e.g., high bandwidth internet connection, then an identifier representing the image can be generated at 625, and the image and the generated identifier can be transmitted to the requesting device at 630. Since the network connection between the repository and the requesting device is strong, the time required to transmit the image can be small. Further, transmitting the identifier to the requesting device can enable a user to select the identifier or share the identifier among other users, thereby enabling more than one user to access the image.

If the requesting device is determined to be a mobile device, then a low resolution version of the image can be generated at 635. In some implementations, if the received image is of the order of a few megabytes in size, the low resolution image can be of the order of a few kilobytes. In addition, more than one low resolution version spanning a range of sizes can also be generated. An identifier representing a low resolution version of the image can be generated at 640. The low resolution image and the corresponding identifier can be transmitted to the mobile device at 645. Since the transmitted image is a low resolution version of the received image, the time required to transmit the image and the processing required to render the image on the mobile device can be small. In implementations where multiple images are received, the multiple images can be grouped, an identifier can be generated to represent the group of images, and the generated identifier can be transmitted to the requesting device. The requesting device can access the group of images as well each image in the group. In this manner, a single image, a group of images, and multiple groups of images can be made available to a mobile device, in response to requests received from the mobile device. The mobile device can be configured to display the image, a group of images, and multiple groups of images in a user interface.

In addition, the mobile device can include navigation tools that can enable a user to switch between the displays to access an image or groups of images of choice. In a first example, multiple groups of images can be displayed as an array of frames, where the array includes rows and columns, each row including a frame displaying the name of a group and a frame displaying an image in the group. In a second example, a group of images can be displayed as an array of frames, where each frame displays an image in the group. In addition, if the group includes content other than images, e.g., a video file, the frame can include an icon to identify the type of content displayed in the frame. In a third example, each image in a group can be individually displayed in a frame in the user interface, where the user interface can also include tools to access the previous and/or the next image. The user interface can also include navigation tools to enable a user to switch displays, e.g., switch from the display in the first example to a display in the second example, and vice versa.

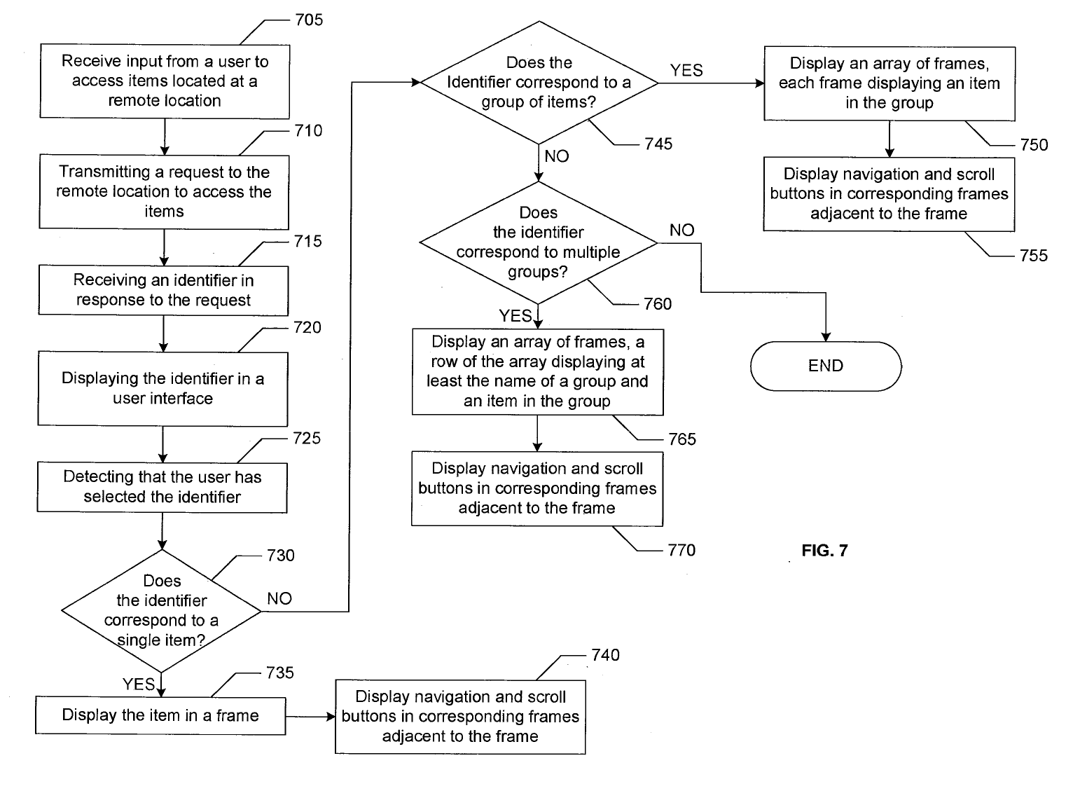

FIG. 7 is a flow chart of an example of a process for transmitting requests from a mobile device for items of digital content, and, upon receiving one or more items in response to the request, displaying the items in a user interface on the mobile device. In some implementations, input can be received from a user of a mobile device to access items located at a remote location at 705. For example, the mobile device can include an icon representing remote access of digital items. A user can provide input to the mobile device by accessing the icon, e.g., by touching the icon. Upon receiving the input, a request can be transmitted from the mobile device to the remote location where the items are located at 710. In some examples, the items of digital content can be placed in the remote location by the user providing input to access the items. The items can be transmitted to the storage location from the mobile device communicating with the remote location over a wireless network, e.g., a cellular telephone network, or a device communicating with the remote location over a network, e.g., the internet. In response to the request, an identifier, e.g., a URL pointing to the location of the item can be received at 715. In some implementations, the URL can be generated at the remote location when the request from the mobile device is received. In other implementations, the URL may have been previously generated in response to a previous request. The URL can be displayed in the user interface at 720. In some implementations, the user can select the URL, and the selection of the URL can be detected at 725. In other implementations, the URL as well as the one or more items of digital content to which the URL points can both be displayed in the user interface on the mobile device.

In some implementations, the identifier can correspond to a single item of digital content, e.g., an image, a video file, an audio file, and the like. A check can be performed to determine if the identifier corresponds to an item of digital content at 730. If yes, then the item can be displayed in a frame in the user interface on the mobile device at 735. For example, a rectangular frame can be displayed in the user interface on the mobile device and the item can be displayed within the boundaries of the rectangular frame. In addition, navigation and scroll buttons can be displayed in one or more corresponding frames adjacent to the frame in which the item is displayed at 740. In some implementations, navigation buttons can enable accessing other items or groups of items at the remote location. In addition, the scroll buttons can also enable accessing other items, and can enable altering the view of the displayed item, e.g., zooming in, panning, and the like. In implementations where the item is a video or audio file, the scroll buttons can include buttons such as “Play,” “Pause,” and the like.

A check can be performed to determine if the identifier corresponds to a group of items, e.g., a container containing multiple items including images, video, audio, and the like. If yes, then multiple items in the group of items can be displayed in the user interface as an array of frames, where each frame can display an item in the group. For example, if the group includes images and video files, each frame in the array can display a thumbnail version of the image within the boundary of the frame. Each frame corresponding to a video file can display a video frame that can be representative of the video file within the boundary of the corresponding frame. If the item is not an image, e.g., is a video file, then an icon, e.g., a picture of a video camera, can be displayed within the boundary of the frame to indicate the type of item. In addition, navigation and scroll buttons can be displayed in corresponding frames adjacent to the frames within which the items are displayed at 755. The navigation button can enable accessing each individual item. For example, a user can select a frame representing an image to view the full image. Similarly, the user can select a frame representing a video file to play the video file. In addition, the scroll buttons can also enable accessing a frame. For example, the scroll buttons can include arrow buttons that can be used to select a frame. A user can select an arrow button until the user arrives at a frame of interest.

In some implementations, a check can be performed to determine if the identifier corresponds to multiple groups, e.g., multiple containers, each container including one or more images at 760. If yes, then the multiple groups can be displayed in the user interface as an array of frames, each row of the array including at least one frame displaying a name of the group and one frame displaying an image in the group at 765. For example, the first row in the array can display “Container 1” as the name of the group in one frame and a thumbnail of an image in the group in an adjacent frame. In addition, navigation and scroll buttons can be displayed in frames adjacent to the array of frames in the user interface at 770. In this manner, various views of the items at the remote location can be displayed in the user interface on the mobile device. For example, displaying the multiple groups in an array of frames can be the group array view, displaying a group of items as an array of multiple frames can be the container view, and displaying each item in a frame can be the item view. The navigation buttons can enable changing the display of the user interface from one view to another, e.g., the container view to the group array view or the container view to the item view. In addition, the scroll buttons can enable accessing items based on the displayed view. In some implementations, the user interface can display the identifier corresponding to the view. For example, since each item is associated a corresponding identifier, selecting an item for display can cause the corresponding identifier to be displayed in the user interface. Additional information about a group such as the name of the group, the number of items in the group, and the like, can also be displayed in the user interface depending on the view.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, near-touch input, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, a container can include more than one type of digital content, e.g., videos, audio files, documents, and the like. The mobile device 110 can be configured to display, within a frame representing an item of digital content, an icon identifying the type of digital content. For example, if the item is a digital video file, the mobile device 110 can be configured to display an image of a video camera adjacent to or in the frame representing the video file. In addition, the mobile device 110 can be configured to display a frame in the video file in the frame to enable the user to identify the video file. In some implementations, the frame can be the first frame in the video file. In other implementations, the frame can be a frame in the video file that contains an image. In other implementations, the frame can be selected by a user.

In some implementations, the MPE 105 can be configured to recognize that the request for content is received from a mobile device 110. The MPE 105 can further be configured to generate a low resolution version of all the images in the content repository 205 to transmit to the mobile device 110 so as to reduce transmission time from the MPE 105 to the mobile device 110, as well as to reduce the load involved in rendering the UI 305 on the mobile device 110. The MPE 105 can include processing capabilities, e.g., Java image processing capabilities, that can be configured to create one or more versions of each image, where each version can represent a different size ranging from small to full resolution. Depending on the view on the UI 305, e.g., the array displaying the containers including a representative image, the array of images in a container, each image in the container, and the like, the MPE 105 can be configured to transmit, for display, to the mobile device 110 one of the different versions of the same image.

In addition, the MPE 105 can be configured to generate identifiers for each generated version as well as identifiers to represent requests received from computers and mobile devices. For example, if the MPE 105 detects that the request for content is received from a computer 115 operatively coupled to the MPE 105 via a high bandwidth network connection, then the MPE 105 can include the device and connection information in a URL, transmit the URL to the requesting device, and store the URL. Similarly, if the MPE 105 detects that the request for content is received from a mobile device 110 operatively coupled to the MPE 105 via a cellular telephone network, then the MPE 105 can generate a URL incorporating such information. When the URL corresponding to a computer 115 connected via the high bandwidth connection is detected, the MPE 105 can transmit full resolution images. Subsequently, the MPE 105 can transmit the same URL to computers 115 connected to the MPE 105 via high bandwidth connections. In contrast, if the mobile device 110 URL is selected, the MPE 105 can transmit the low resolution images and store the mobile device 110 URL. Subsequently, when requests from mobile devices are received, the MPE 105 can transmit the mobile device URL including the low resolution images.

In some implementations, upon generating the URL in response to a first request from a mobile device 110, the MPE 105 can be configured to store the URL. When a second request for content is received from a device, the MPE 105 can be configured to check that the second request is received from a device similar to the one that placed the first request. If the devices are similar, then the MPE 105 can be configured to check for updates to the content repository 205, the updates including adding, deleting, altering content, and the like. In the absence of updates, the MPE 105 can be configured to transmit the stored URL to the requesting device. In this manner, the MPE 105 can reduce the transmission time from when a request is placed to when the content is transmitted as well as reduce the processing load on the MPE 105.

In some implementations, the container can include an audio file, e.g., an mp3 file. The MPE 105 can be configured to identify information related to the audio file, e.g, from the associated metadata, determine an image relevant to the audio file, e.g., album art for the album to which the audio file corresponds, and display, in the UI 305, the corresponding image in the frame representing the audio file. In some implementations, the MPE 105 can be configured to group the content according to the type of content. For example, in a default implementation, a container can include a collection of content types, e.g., images, audio, video, and the like. Upon receiving multiple containers containing different types of content, the MPE 105 can be configured to group the items of content based on type, e.g., image container, video container, and the like, further separate the container based on factors including time of capture, location of capture, and the like, and display each type of item in a corresponding item container in the UI 305. Thus, all the images can be grouped into a group of image containers and all the videos can be grouped into a group of video containers. The MPE 105 can further be configured to generate URLs for each grouped container and make the URLs available to a user. In some implementations, the container representing a group of images can be skimmed, such that when an input device, e.g., a user's finger is slid across the frame representing the container, either the frame representing the container or a separate frame can be updated with the one or more images in the container, where the position of the input device on the frame representing the container corresponds to an image in the container. Accordingly, other embodiments are within the scope of the following claims.

What is claimed is:

1. A computer-implemented method comprising:
receiving from a mobile device communicating over a wireless network a request for a content item;
generating an identifier to represent a network location at which the content item is stored; and
transmitting the identifier and the content item to the mobile device, wherein the mobile device is configured to perform operations including:
display the item in a first frame in a user interface on the mobile device;
display the identifier in a second frame in the user interface, and
enable a user to perform manipulations on the content item of content.

2. The method of claim 1 wherein the manipulations include at least one of viewing, zooming, panning, and scrolling.

3. The method of claim 1 further comprising:
receiving the content item from a device over a network; and
storing the content item in a repository.

4. The method of claim 3 wherein the device is the mobile device and the network is the wireless network.

5. The method of claim 1 wherein the identifier is a uniform resource locator.

6. The method of claim 1 wherein the content item is a digital image.

7. The method of claim 6 further comprising:
receiving the digital image from a device over a network;
detecting that the device requesting the content item is the mobile device;
generating one or more low resolution versions of the digital image;
generating one or more low resolution identifiers corresponding to the one or more low resolution versions; and
transmitting one of the low resolution versions and the corresponding low resolution identifier to the mobile device.

8. The method of claim 1 further comprising:
storing the transmitted identifier;
receiving a second request for the content item from a second mobile device over the network; and
upon determining that the content item is unchanged in the duration between when the first request was received and the second request is received, transmitting the stored identifier and the content item to the second mobile device.

9. The method of claim 1 further comprising:
receiving a plurality of content items;
storing the plurality of items in a repository at the network location;
generating a second identifier to represent the repository; and
upon receiving a request from a mobile device over the wireless network for the plurality of items, transmitting the second identifier to the mobile device.

10. The method of claim 9 wherein the mobile device is configured to perform operations including:
displaying each item of the plurality of items in corresponding frames arranged in one or more rows on a user interface on the mobile device;
displaying the second identifier in an identifier frame on the user interface; and
enabling a user to perform manipulations on the plurality of frames, the manipulations including at least one of selecting one of the plurality of items, displaying in the user interface only the selected one of the plurality of items, and navigating to access a first view displaying one of the plurality of items or a second view displaying the plurality of items.

11. A medium bearing instructions to enable one or more machines to perform operations comprising:
receiving from a mobile device communicating over a wireless network a request for a content item;
generating an identifier to represent a network location at which the content item is stored; and
transmitting the identifier and the content item to the mobile device, wherein the mobile device is configured to perform operations including:
display the item in a first frame in a user interface on the mobile device;
display the identifier in a second frame in the user interface, and
enable a user to perform manipulations on the content item.

12. The medium of claim 11 wherein the manipulations include at least one of viewing, zooming, panning, and scrolling.

13. The medium of claim 11 further comprising:
receiving the content item from a device over a network; and
storing the content item in a repository.

14. The medium of claim 13 wherein the device is the mobile device and the network is the wireless network.

15. The medium of claim 11 wherein the identifier is a uniform resource locator.

16. The medium of claim 11 wherein the content item is a digital image.

17. The medium of claim 16 further comprising:
receiving the digital image from a device over a network;
detecting that the device requesting the content item is the mobile device;
generating one or more low resolution versions of the digital image;
generating one or more low resolution identifiers corresponding to the one or more low resolution versions; and
transmitting one of the low resolution versions and the corresponding low resolution identifier to the mobile device.

18. The medium of claim 11 further comprising:
storing the transmitted identifier;
receiving a second request for the content item from a second mobile device over the network; and
upon determining that the content item is unchanged in the duration between when the first request was received and the second request is received, transmitting the stored identifier and the content item to the second mobile device.

19. The medium of claim 11 further comprising:
receiving a plurality of content items;
storing the plurality of items in a repository at the network location;
generating a second identifier to represent the repository; and
upon receiving a request from a mobile device over the wireless network for the plurality of items, transmitting the second identifier to the mobile device.

20. The medium of claim 19 wherein the mobile device is configured to perform operations including:
displaying each item of the plurality of items in corresponding frames arranged in one or more rows on a user interface on the mobile device;
displaying the second identifier in an identifier frame on the user interface; and
enabling a user to perform manipulations on the plurality of frames, the manipulations including at least one of selecting one of the plurality of items, displaying in the user interface only the selected one of the plurality of items, and navigating to access a first view displaying one of the plurality of items or a second view displaying the plurality of items.

21. A computer-implemented method for displaying one or more content items on a mobile device comprising:
transmitting a request for one or more content items from a mobile device;
receiving one or more identifiers corresponding to the one or more content items; and
upon detecting that a user has selected an identifier of the one or more identifiers:
retrieving a corresponding item, and
displaying an image corresponding to the corresponding item in a frame in a user interface on the mobile device.

22. The method of claim 21 wherein an identifier corresponds to one or more items collected into a group.

23. The method of claim 22 further comprising displaying the one or more items of the group in an array of frames, wherein an image corresponding to an item is displayed in a frame in the array.

24. The method of claim 23 further comprising displaying the identifier corresponding to the group in a frame adjacent to the array.

25. The method of claim 21 wherein an identifier corresponds to a plurality of groups, a group corresponding to one or more items.

26. The method of claim 25 further comprising displaying the plurality of groups in an array, wherein a row in the array comprises at least a first frame containing information enabling identification of a first group and at least a second frame displaying an image corresponding to an item in the first group.

27. The method of claim 26 wherein the information enabling identification of a first group includes a name of the first group.

28. The method of claim 26 further comprising displaying the identifier corresponding to the plurality of groups in a frame adjacent to the array.

29. The method of claim 26 further comprising displaying navigation buttons adjacent to the array wherein the navigation buttons enable the user to access items in a group.

30. A medium bearing instructions to enable one or more operations to perform operations comprising:
transmitting a request for one or more content items from a mobile device;
receiving one or more identifiers corresponding to the one or more content items; and
upon detecting that a user has selected an identifier of the one or more identifiers:
retrieving a corresponding item, and
displaying an image corresponding to the corresponding item in a frame in a user interface on the mobile device.

31. The medium of claim 30 wherein an identifier corresponds to one or more items collected into a group.

32. The medium of claim 31 further comprising displaying the one or more items of the group in an array of frames, wherein an image corresponding to an item is displayed in a frame in the array.

33. The medium of claim 32 further comprising displaying the identifier corresponding to the group in a frame adjacent to the array.

34. The medium of claim 30 wherein an identifier corresponds to a plurality of groups, a group corresponding to one or more items.

35. The medium of claim 34 further comprising displaying the plurality of groups in an array, wherein a row in the array comprises at least a first frame containing information enabling identification of a first group and at least a second frame displaying an image corresponding to an item in the first group.

36. The medium of claim 35 wherein the information enabling identification of a first group includes a name of the first group.

37. The medium of claim 35 further comprising displaying the identifier corresponding to the plurality of groups in a frame adjacent to the array.

38. The medium of claim 35 further comprising displaying navigation buttons adjacent to the array wherein the navigation buttons enable the user to access items in a group.
